(19) United States
(12) Patent Application Publication
(10) Pub. No.: US 2012/0201277 A1
(43) Pub. Date: Aug. 9, 2012

(54) Solar Powered Simplex Tracker

(76) Inventors: Ronnie Daryl Tanner, Covington, LA (US); Walter Debus, Covington, LA (US)

(21) Appl. No.: 13/368,111

(22) Filed: Feb. 7, 2012

Related U.S. Application Data
(60) Provisional application No. 61/440,717, filed on Feb. 8, 2011.

(51) Int. Cl. H04B 1/00

(52) U.S. Cl. 375/141; 375/E01.002

(57) ABSTRACT

A asset group tracking system which includes a plurality of solar powered tracking devices on separate assets. Each of the tracking devices further includes: (i) a Global Navigation Satellite System (GNSS) receiver; (i) a transceiver; (iii) a processor controlling the GNSS receiver and transceiver; (iv) a rechargeable battery powering one or more of the GNSS receiver, the transceiver, or the processor; and (v) a solar power collector for charging the battery. In the system, a minority of the tracking devices further include a satellite transmitter.

This application claims the benefit under 35 USC §119(e) of us provisional application Ser. No. 61/440,717 filed Feb. 8, 2011, which in incorporated by reference herein in its entirety.

### BACKGROUND

The present invention relates to apparatus and methods for tracking, monitoring, and locating persons, animals, and physical assets using GPS and simplex satellite devices.

One specialized tracking application applies to the production and exportation of livestock and livestock byproducts, which has increased steadily over the past decade. Along with this growth in the industry, there is an elevated social awareness of the environmental impact this is causing in many environmentally sensitive areas of the world such as Brazil where the increase in livestock population is having a negative impact on the Amazon rain forest. In addition, there is also an increased concern over the health dangers and financial impact of disease outbreaks in livestock, especially cattle.

These concerns have created an increased desire to monitor livestock herds in real time in order to ensure the animals have not grazed in protected areas and to provide a detailed history of the proximity of the herds during outbreaks of disease.

Some governments are now requiring that the livestock byproducts sold in their country must be certified to be from herds that have not grazed in protected areas. Until recently, the technology to monitor individual livestock over their lifetime in the vast open ranges where they graze has not been possible. The current RF technology employed is limited to short range detection which does not provide real-time monitoring of the animals over their grazing range. Satellite communications systems have historically been too bulky and expensive for use in this application.

### BRIEF DESCRIPTION OF THE DRAWINGS

The various features, functionalities and practical advantages of the example embodiments described herein may be more readily understood with reference to the following detailed description taken in conjunction with the accompanying drawings, wherein like reference numerals designate like structural elements, and in which:

FIG. 1 illustrates an exemplary solar simplex tracker device;

FIG. 2 illustrates an alternative solar simplex tracker device;

FIG. 3 illustrates an exemplary terrestrial tracker device;

FIG. 4a illustrates an exemplary solar ruggedized enclosure;

FIG. 4b illustrates an ear tag embodiment;

FIG. 5 illustrates an exemplary simplex animal tracker network;

FIG. 6 illustrates an alternative simplex animal tracker network;

FIG. 7 illustrates an alternative simplex animal tracker network;

FIG. 8 illustrates one example circuit for regulating charge to the battery.

FIG. 9 illustrates an alternative simplex animal tracker.

FIG. 10 illustrates one embodiment of a wireless sensor component.

FIG. 11 illustrates another embodiment of a wireless sensor component.

### DETAILED DESCRIPTION

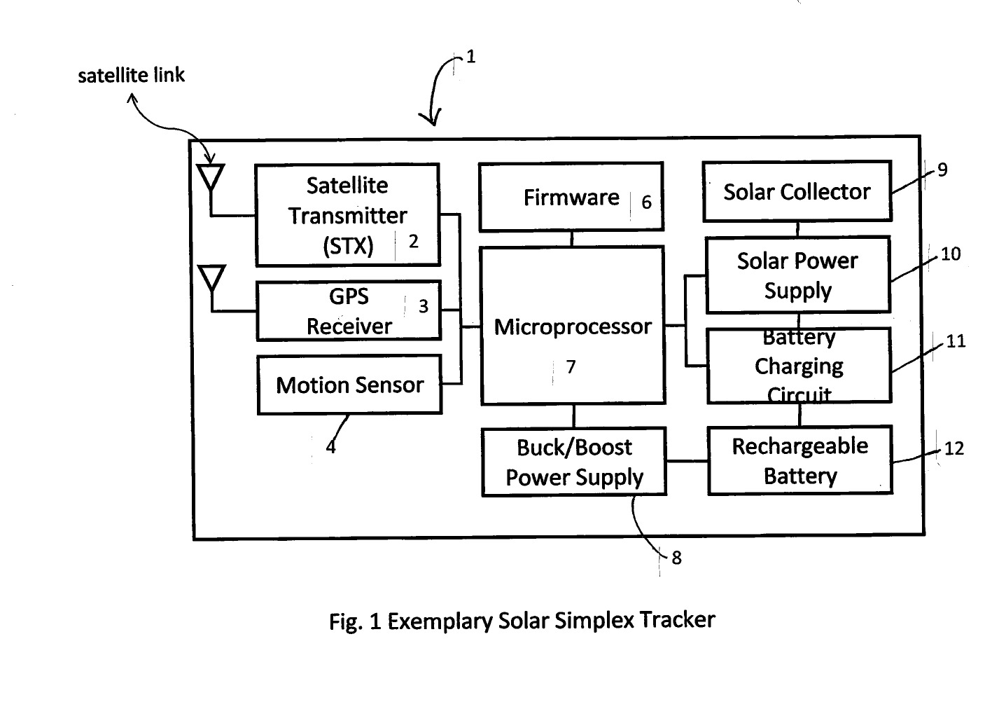

Disclosed herein are various non-limiting examples of apparatuses and methods for tracking, monitoring, and locating persons, livestock, and other physical assets. An exemplary embodiment shown in FIG. 1 comprises a compact tracking device 1 containing a GPS receiver 3, a simplex satellite transmitter 2, a microprocessor 7, firmware 6, a motion sensor 4, a solar collector 9, a solar power supply 10, a battery charging circuit 11, and a rechargeable battery 12. This example may further include a buck/boost power supply 8 (i.e. a conventional type of DC-to-DC converter that has an output voltage magnitude that is either greater than or less than the input voltage magnitude); however other embodiments may be used without the buck/boost converter.

The solar simplex tracker 1 of FIG. 1 is powered by the rechargeable battery 12. The battery is maintained in a charged condition by the solar power circuitry consisting of the solar collector 9, the solar power supply 10, and the battery charging circuit 11. The solar collector consists of a plurality of solar cells which convert available light energy into electrical energy. The solar power supply receives the electrical energy from the solar collector and converts the unregulated voltage of the solar cells to a constant operating voltage that is provided to the battery charging circuit. In one embodiment, solar collector/power supply component could be a MAX1795EUA manufactured by Maxim Intergrated Products of Sunnyvale, Calif. The microprocessor 7 monitors the output voltage of the solar power supply and the operating voltage of the rechargeable battery and provides a charging current to the battery and thereby maintains the proper charge to the battery. The charge current capacity of the solar power supply will vary based on the amount of available light. The microprocessor will adjust the amount of charging current to the battery so that the maximum charging current is used under a variety of lighting conditions.

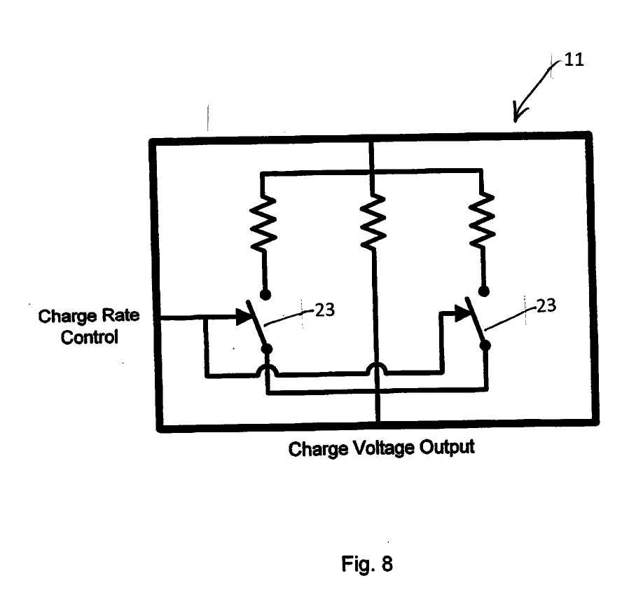

FIG. 8 illustrates one embodiment of the battery charging circuit 11. The processor opens and closes the two switches 23 independently to control the charge rate of the battery. In this manner, the processor 7 can choose zero charge rate (by disabling the solar supply), the nominal charge rate, 2 times the nominal charge rate, and 4 times the nominal charge rate (i.e., the processor controls a multi-switch circuit to vary the charge rate). In the case where the processor is under-powered due to a low battery, the solar supply/charging circuit 11 self biases to produce the nominal charge rate and the processor keeps the load circuitry in a low power sleep state. The processor may also set charge voltage termination level below the battery's fully charged voltage level in order to extend the life of the battery.

One preferred battery type is a lithium-ion polymer battery, but many alternative rechargeable battery types may be employed, including lithium-ion, and lithium iron magnesium phosphate batteries. Using the circuit described above (or a similarly functioning circuit), the microprocessor monitors the battery voltage and provides protection from over-charging and over-discharging.

The microprocessor 7, satellite transmitter 2, and GPS receiver 3 are operated using a regulated output from the rechargeable battery 12. In certain embodiments, the tracking device includes a motion sensor 4 which is capable of detecting movement of the tracking device 1. The processor 7 in the tracking device may then perform power consuming activities, such as taking GPS readings or more particularly transmitting location data via the satellite transmitter 2, only when movement is detected or motion is detected over some defined time period. Likewise, the processor may alter its reporting rate base on detecting movement (or motion over time). Still further embodiments could not utilize a motion sensor 4, but could detect a change of position by comparing GPS reading over time. Then the current location could be transmitted to the satellite network when a location change over a given magnitude was detected.

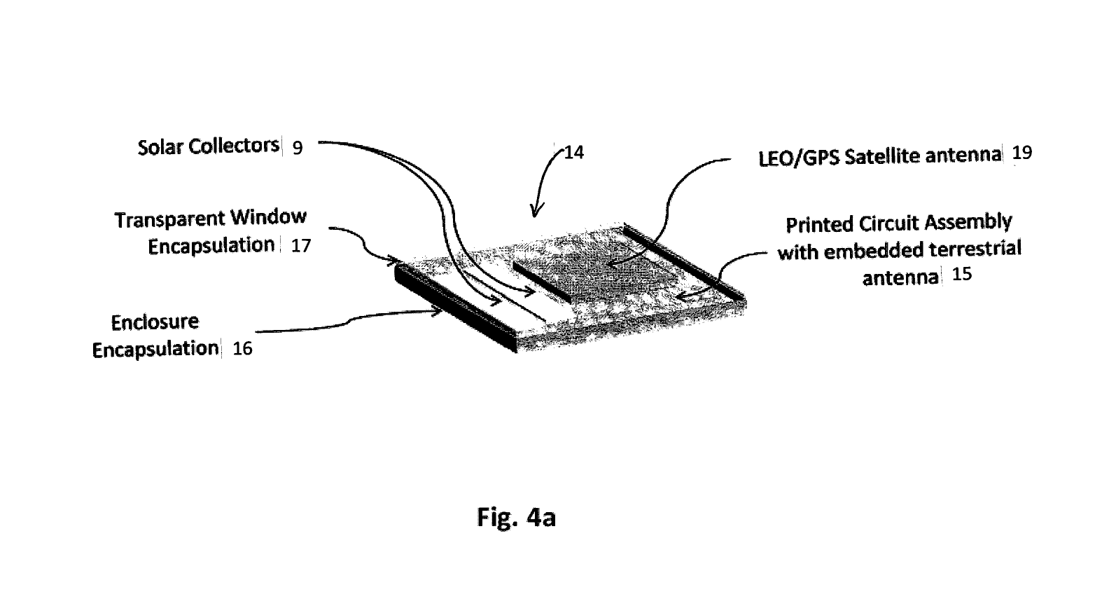

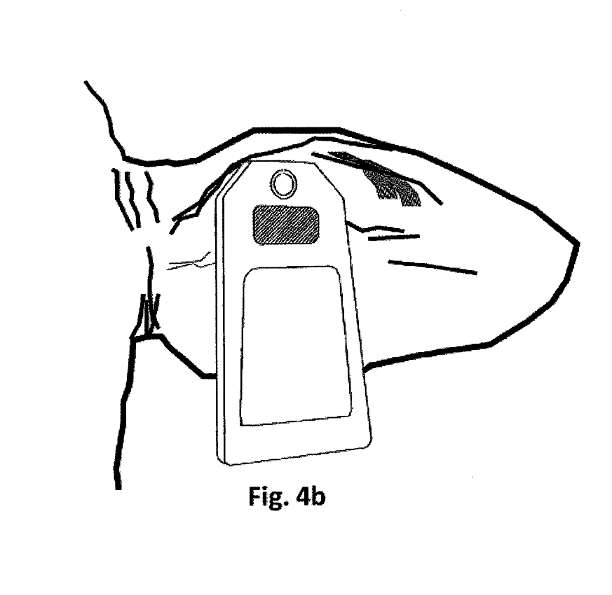

In one preferred embodiment, the tracking device includes a housing which is in the form of a livestock ear tag which is positioned in the ear of a livestock animal as suggested in FIG. 4b. In another embodiment, the tracking device housing is in the shape of or is connected to a livestock collar positioned around the neck of the livestock.

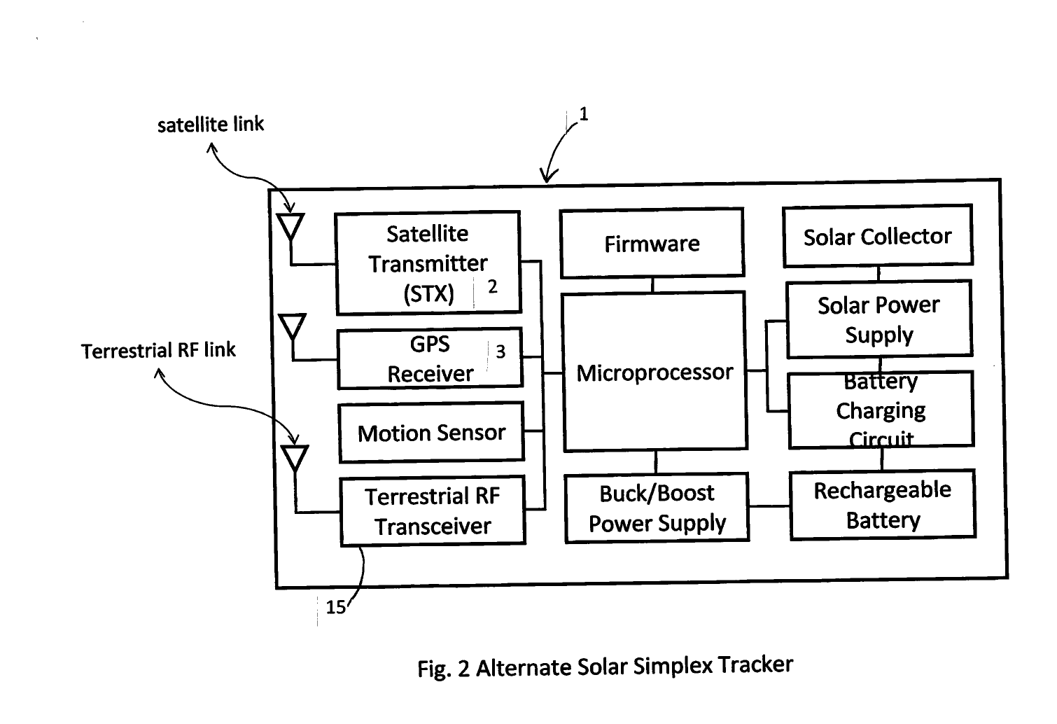

FIG. 2 illustrates an alternative solar tracker which further includes a terrestrial RF transceiver 15. The terrestrial RF transceiver 15 allows the solar tracker 1 to network with other tracking devices (also having RF transceivers) within the transceiver's range. In certain embodiments, the terrestrial transceiver is a comparatively short range receiver having ranges of less than either 5 km, 1 km, 0.5 km, 0.3 km, 0.1 km, or 0.05 km. One example RF transceiver is the ZICM2410P2-2 produced by California Eastern Laboratories of Santa Clara, Calif. Other example could include the 450-0017 produced by LS Research of Cedarburg, Wis. or the NRF2401A produced Nordic Semiconductor of Oslo, Norway.

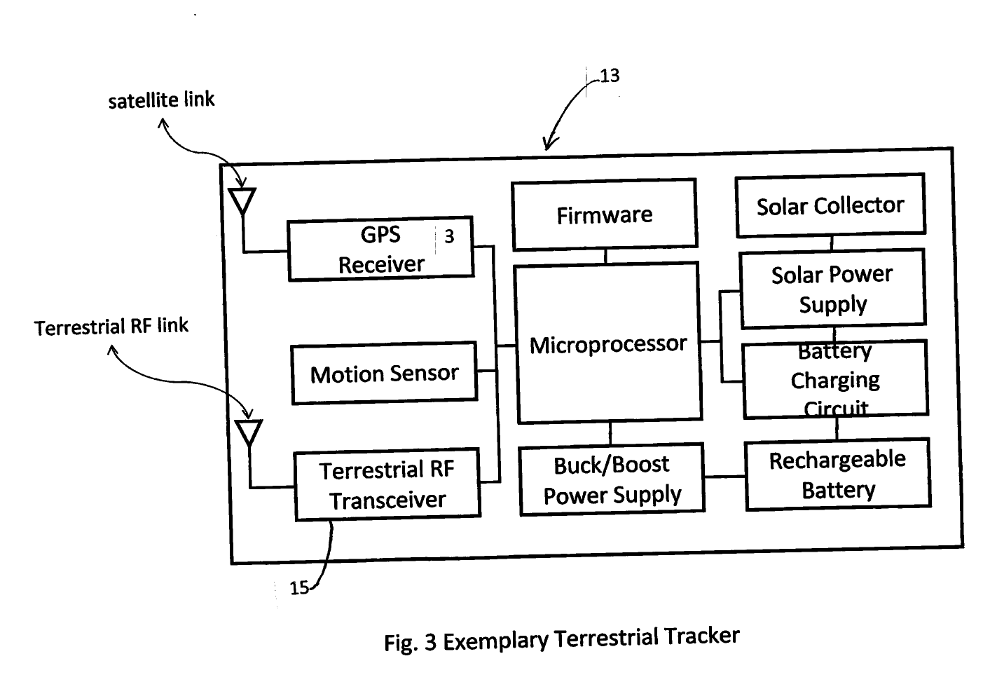

The scope of invention includes many variations on the devices of FIGS. 1 and 2. FIG. 3 illustrates one example of an alternative “terrestrial” tracker device 13 which does not contain a satellite transmitter. However, the FIG. 3 tracker includes the terrestrial RF transceiver 15 allowing it to network with other tracker devices, including other tracker devices which do possess satellite transmitters 2 as in FIG. 2.

FIG. 4a illustrates one embodiment of a tracker housing or enclosure 14. The lower portion 16 of the housing is planar, weather impervious substrate onto which a printed circuit board assembly 15 is positioned. Together with other tracker components, one or more solar collectors 9 are positioned on the circuit board. Thereafter, a solar transparent encapsulation material 17 is applied over the tracker components to form a weather/moisture proof housing. The encapsulation material is solar transparent in the sense that it is substantially transparent to the light spectrum which drives the solar collectors. Example encapsulating materials could include PETG (Polyethylene terephthalate) or ABS (Acrylonitrile-Butadine-Styrene) Polycarbonate. As an alternative to having a tracker housing of separate components, the tracker circuitry could potted in an encapsulating material.

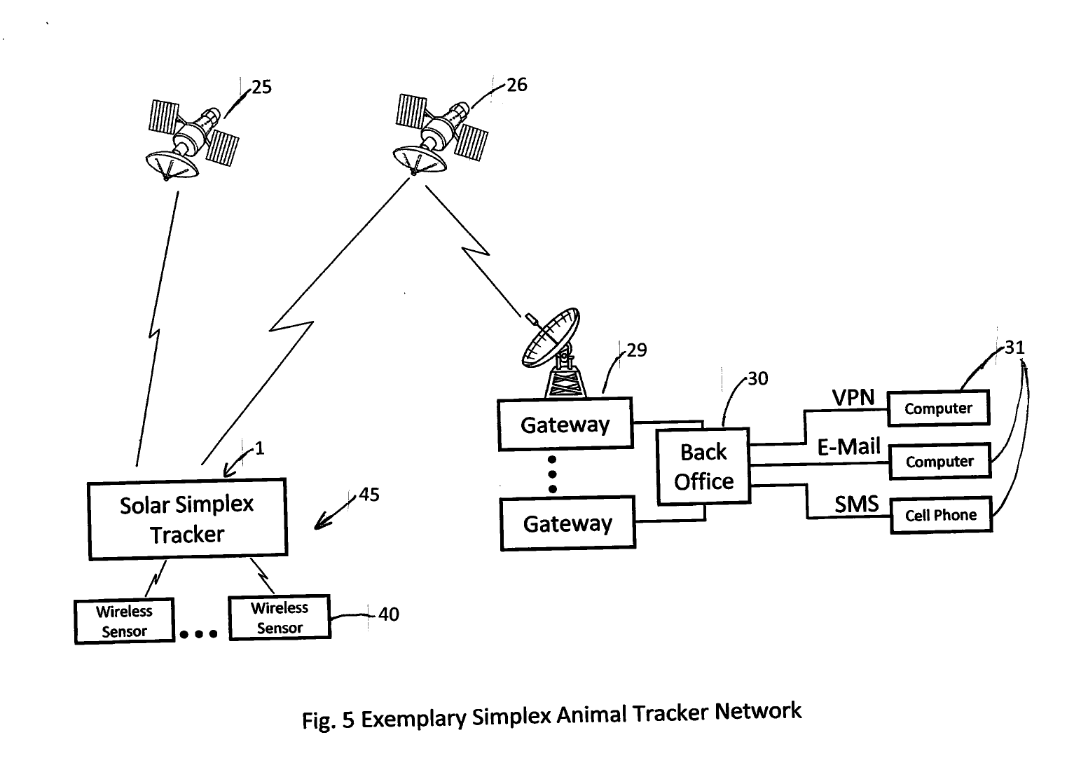

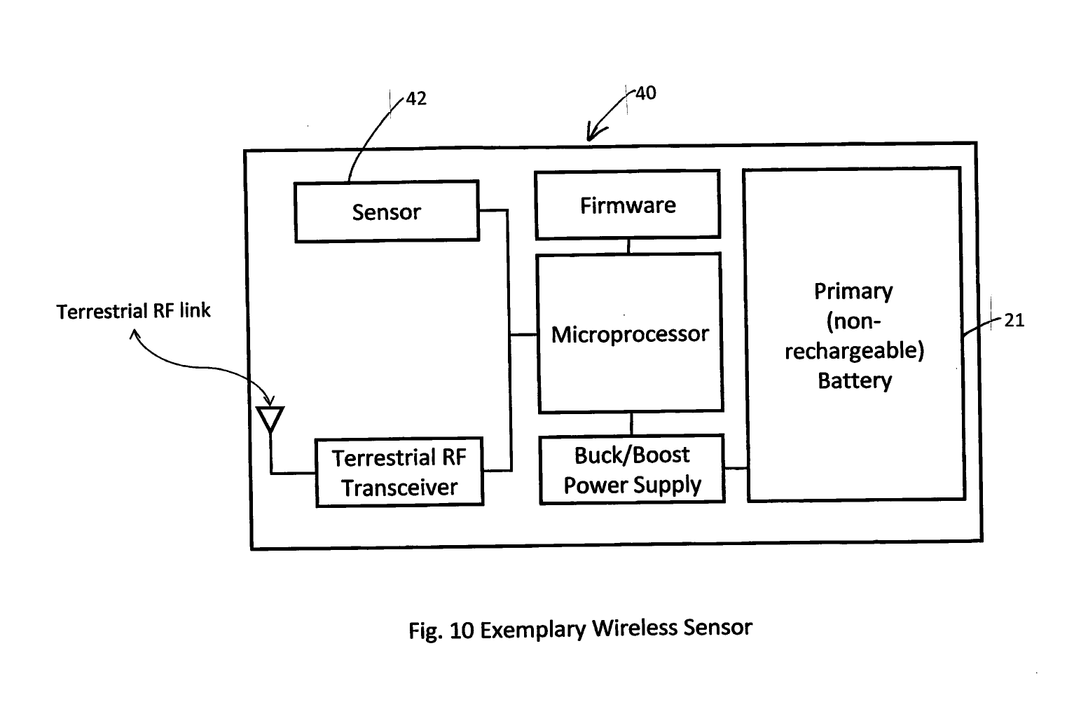

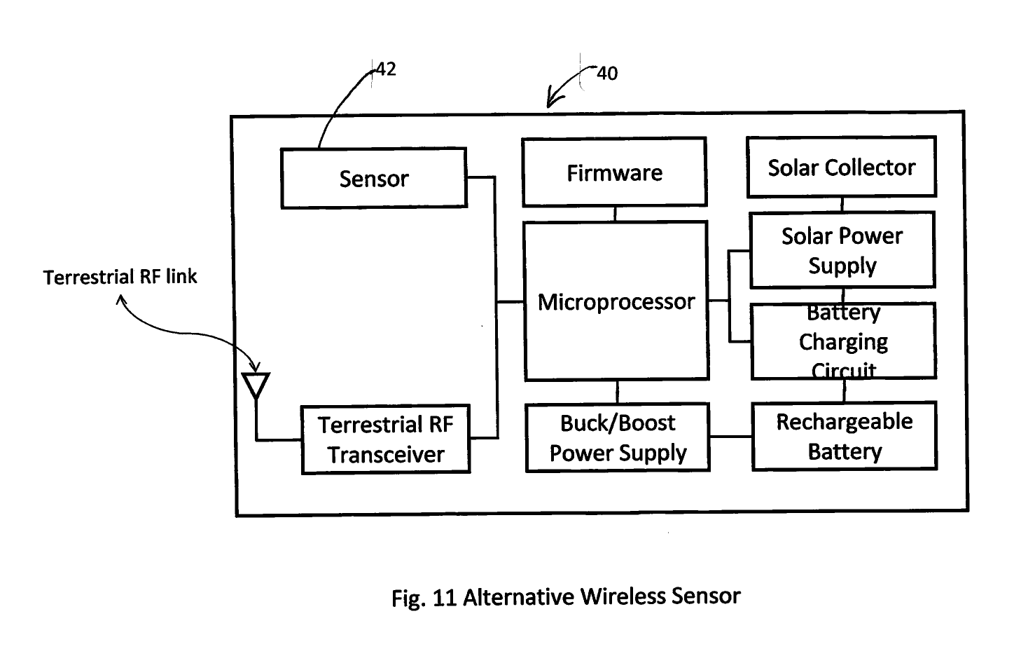

FIG. 5 illustrates one tracker network 45 wherein information, primarily location information derived from GPS satellite network 25, but also status information about the asset to which the tracker is attached (such as obtained from the wireless sensor 40 described in more detail below), is transmitted through a communication satellite network 26 and gateway 29 to a back-office 30 and eventually to end user devices 31. As suggested in FIG. 5, the tracker network 45 may include not only simplex tracker devices 1 such as in FIG. 2, but also sensor devices 40 such as FIGS. 10 and 11. In the case where the assets are cattle, certain animals in the head would be tagged with simplex tracker devices 1 and other animals tagged with sensor devices 40.

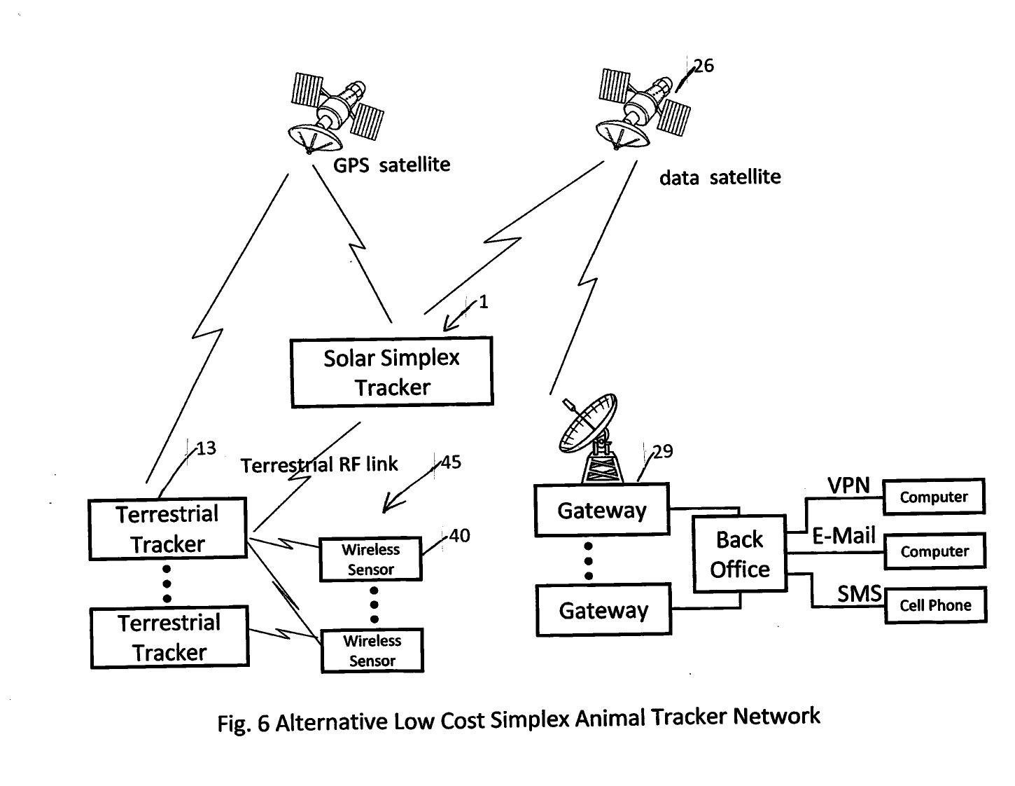

FIG. 6 illustrates the network where certain trackers 13 and 40 in the network do not transmit to a satellite network 26, but rather use a terrestrial transceiver 15 (e.g., see FIG. 3) to transmit information to another tracker. At some point, the information is transmitted to a tracker 1 with a satellite transmitter 2 and the information from the various trackers 13 and 40 is transmitted via this latter, satellite enabled, tracker device.

In certain embodiments, the information transmitted between terrestrial transceivers 15 is in the form of a data packet which may include various types of information, non-limiting examples of which are identification information, location data, or sensor data. Identification information may be a tag serial number or other identifier unique to the individual tracking device. Location data is any type of data which can be used to identify the location of the tracking device, including a global location reference (i.e., latitude and longitude) or a location reference by providing a relative position to another known location or position. Sensor data may include any type of data derived for a sensor on the tracking device, such as temperature of the asset carrying the tracking device.

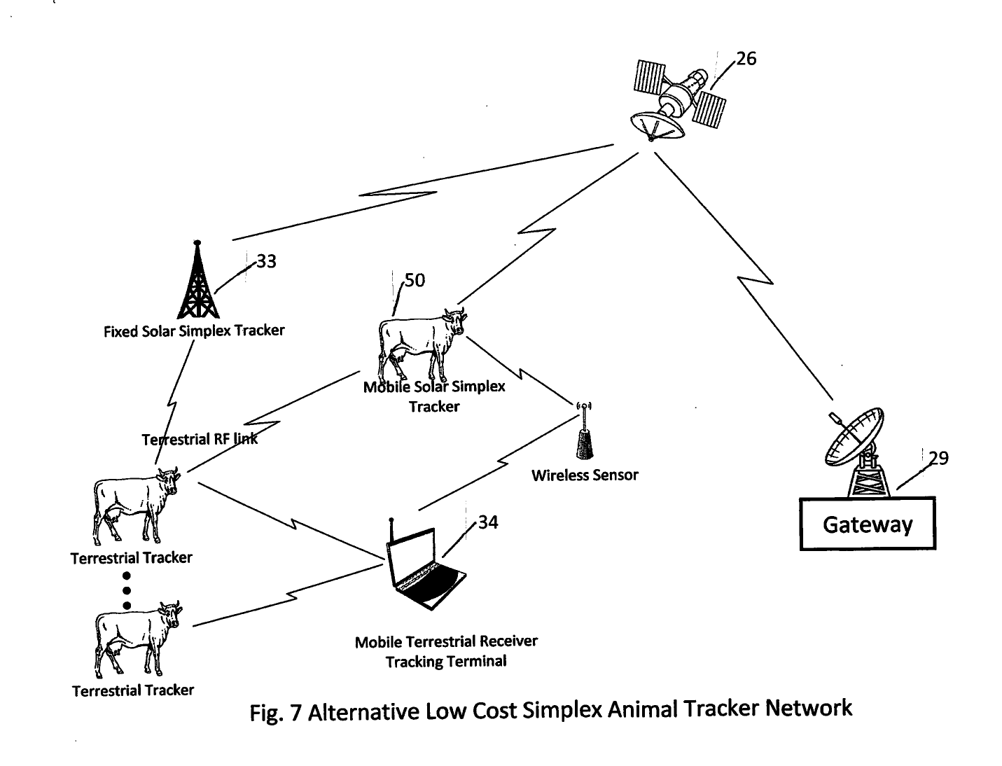

FIG. 7 illustrates a modification to the network shown in FIG. 6. The FIG. 7 network further includes a fixed relay device 33 which includes a terrestrial transceiver 15 and a satellite transmitter 2. The relay device can transmit to the satellite network 26 data collected from tracker devices 1 and 13 and wireless sensors 40 within range of the fixed relay device's terrestrial transceiver. The network may also include a mobile relay device 34 which also has a terrestrial transceiver 15 and may or may not include a satellite transmitter 2.

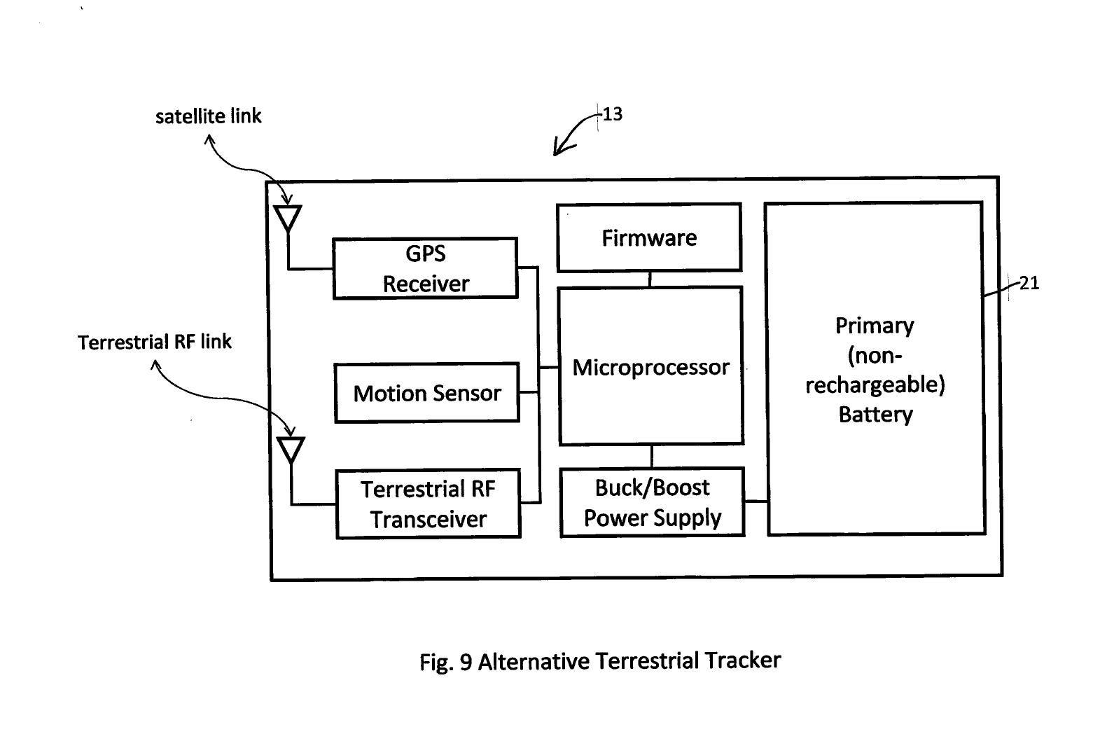

FIG. 9 illustrates an alternative Terrestrial Tracker 13 which is identical to the embodiment shown in FIG. 3 but lacks the solar re-charging circuitry and includes a non-rechargeable battery 21.

FIG. 10 illustrates one embodiment of the wireless sensor 40 (which in one example could be in the form of an animal tag). This embodiment contains a terrestrial transceiver 15 to communicate to one or more terrestrial trackers 13 or satellite trackers 1 as well as stationary or mobile terrestrial receiver tracking terminals 33 and 34. It uses a non-rechargeable battery 21 for its power source. The wireless sensor tag 40 may be designed to sense the condition of an asset to which the tag is attached. For example the sensor component 42 could be configured to detect the temperature (or other biometric conditions) of an animal to which the tag is connected.

FIG. 11 illustrates an additional embodiment of the wireless sensor 40. This embodiment contains a terrestrial transceiver 15 to communicate to one or more terrestrial trackers 13 or satellite trackers 1 as well as stationary or mobile terrestrial receiver tracking terminals. It contains solar charging circuitry and a re-chargeable battery for its power source.

On embodiment of the current invention provides an improved means of tracking, monitoring, and real-time reporting using a compact satellite transmitter utilizing a self-contained power source that is capable of operating the device for 2-5 years. In addition to tracking livestock, a tracking device with a self-contained power source has many alternative uses, some of which have been described above in more detail.

Where the above description describes a “simplex tracker” (i.e., a device employing a simplex satellite transmitter), it will be understood that a duplex satellite transceiver may be a possible (although more costly) alternative. It will also be understood that cattle and other livestock are considered “assets” as that term is used herein. Likewise, where the term “transmitter” or “receiver” is used, this may include a transmit/receive only device or it may include a transceiver.

A data relay network includes any wireless network where data is transferred from a local area to a remote area. One example of a data relay network is a tracking tag with a satellite transmitter communicating with a satellite network. Another example of a data relay network is tacking tag communicating with a terrestrial (fixed location or mobile) radio system, which in turn has a satellite transmitter which communicates with a satellite network (or alternatively with an in-range cellular GSM network).

Another example embodiment of the invention includes a solar powered satellite tracking device comprising: (a) a Global Navigation Satellite System (GNSS) receiver; (b) a satellite transmitter; (c) a processor controlling the GNSS receiver and satellite transmitter; (d) a rechargeable battery powering one or more of the GNSS receiver, the satellite transmitter, or the processor; and (f) a solar power collector for charging the battery. One alternative embodiment would include one or more sensor components sensing various conditions of the asset to which the tracking device is attached.

In certain embodiments, the GNSS receiver is one of a GPS, GLONASS, Galileo or Beidou receiver. Alternatively, the solar powered tracking device may further comprise (i) a battery charging circuit connected to the battery and regulating power to the battery in order to prevent overcharging; (ii) a Buck/Boost power supply which operates to regulate the power supply to one or more of the satellite transmitter, GNSS receiver, or the processor and allows the device to continue operating down to a lower battery voltage; or (iii) a motion sensor which triggers when location readings are transmitted by the satellite transmitter. More particularly, a location reading is transmitted when the motion sensor continues to detect motion over a period of time.

Additionally, in certain solar powered tracking devices, the satellite transmitter is a simplex transmit only device and in other tracking devices the satellite transmitter is a transceiver device. Likewise, in certain embodiments the battery comprises a lithium polymer cell and in other embodiments the battery comprises a lithium iron magnesium phosphate cell.

Housing structures may also vary among embodiments, for example where (i) the circuit components are enclosed within a weatherproof housing; (ii) the housing encloses the battery such that the battery cannot be charged by external contacts; (iii) at least a portion of the housing is formed by an encapsulation material which is substantially transparent for those wavelengths of light (visible and/or invisible) which are converted by the solar cells into charge current; or (iv) the housing is substantially formed by an encapsulation material and the encapsulation material consists essentially of a resin.

In other embodiments, the tracking device's processor (i) monitors the battery voltage and stops transmitting GNSS location readings once the battery voltage falls below a given threshold; or (ii) monitors the battery voltage and switches to a low current mode once the battery voltage falls below a given threshold (for example, where the low voltage is between the levels of about 1 V and about 5 V). The processor may also vary the charge rate of the battery or control a multi-switch circuit to vary the charge rate.

Other power saving techniques include: the processor (i) disabling the GNSS receiver and satellite transmitter after a fixed number of days of service in order to clear outdated transmitter traffic off the satellite network; or (ii) being programmed to stop operating the GNSS receiver and satellite transmitter after a fixed number of days in service. In either of these cases the processor may use a GPS constellation date to determine the number of days in service (e.g., the fixed number of days is between 200 and 1200 days (or any range therebetween)). Likewise, an embodiment of the tracking device has the processor monitor the battery voltage and (i) decreases the recharging voltage to protect the battery from over-charging and/or (ii) limits device activity to protect the battery from over-discharging.

In another embodiment, the tracking device's the satellite transmitter is programmed transmit location fixes to the satellite network at a first reporting rate and then the reporting rate to the user through the back-office network is reduced to achieve tiered service plans. For example, the reporting rate to the user through the back-office network may be alternatively about twice per hour, once per hour, six times per day, twice per day, or once per day.

In certain embodiments, the tracking device is capable of detecting movement. In one instance, the device detects movement with an onboard sensor. Alternatively, the device detects movement by comparing two or more GNSS position readings. In either case, the processor may alter its position reporting rate based upon detecting movement.

Other tracking devices include a housing which is in the form of a livestock ear tag which is positioned in the ear of a livestock animal; or the housing is in the form of a livestock collar positioned around the neck of the livestock. As a still further alternative, the housing may be positioned on an item of headgear worn by a person (e.g., motorcycle, bicycle, or combat helmet). In certain embodiments, the tracking device housing is positioned on the visor of a protective (e.g., motorcycle) helmet. The tracking device does not need to be positioned on a device constantly exposed to sunlight, and may be positioned on a physical asset in a location at least periodically exposed to sunlight.

Another embodiment comprises an asset monitoring network comprising (a) a plurality of asset monitoring devices wherein each device comprises: (i) a terrestrial transmitter; (ii) a processor controlling the terrestrial transmitter; (iii) a battery powering the terrestrial transmitter and processor; and (b) wherein the monitoring devices transmit a data packet to either (i) one another; or (ii) a data relay network. In this embodiment, the data relay network may include a satellite network. This data relay network may further include a mobile terrestrial receiver capable of receiving data packets from the monitoring devices and having a satellite transmitter to relay the data packets to the satellite network. In another variation, the data relay network includes a stationary terrestrial receiver capable of receiving data packets from the monitoring devices and having a satellite transmitter to relay the data packets to the satellite network.

This asset monitoring network may be modified wherein at least one monitoring device has a GNSS receiver and location information is transmitted in the data packet; or wherein at least one monitoring device has a satellite transmitter and transmits a data packet to the satellite network. Likewise, the monitoring device with the satellite transmitter may transmit the data packets of other monitoring devices in the network to the satellite network. In one example of this asset monitoring network, the asset is an animal and data packet includes biometric data of the animal. In another example, a majority of the monitoring devices have a terrestrial transmitter and lack a satellite transmitter. Known techniques such as seen in US Publication Application No. 2005/0145187 and U.S. Pat. No. 7,830,257 (both of which are incorporated by reference herein in their entirety) may be combined with the above described embodiments. All such variations described above are intended to fall within the scope of the claims.

1. A asset group tracking system comprising a plurality of solar powered tracking devices on separate assets, each of the tracking devices comprising:
a. a Global Navigation Satellite System (GNSS) receiver;
b. a transceiver;
c. a processor controlling the GNSS receiver and transceiver;
d. a rechargeable battery powering one or more of the GNSS receiver, the transceiver, or the processor; and
f. a solar power collector for charging the battery;
g. wherein a minority of the tracking devices further include a satellite transmitter.

2. The asset group tracking system according to claim 1, wherein the transceiver is a terrestrial radio transceiver.

3. The asset group tracking system according to claim 2, wherein a majority of the tracking devices transmit via the transceiver their GNSS location to the tracking device having the satellite transmitter.

4. The asset group tracking system according to claim 2, wherein the tracking device having the satellite transmitter transmits only its own location and/or additional data such as temperature to a satellite network.

5. The asset group tracking system according to claim 3, wherein the tracking device having the satellite transmitter transmits the location and/or additional data such as temperature of other tracking devices which it has received via the radio transceiver.

6. The asset group tracking system according to claim 3, wherein the tracking device having the satellite transmitter only transmits the location of another tracking device if that tracking device is over a defined distance from the tracking device having the satellite transmitter.

7. The asset group tracking system according to claim 1, wherein the satellite transmitter is a simplex transmitter.

8. The asset group tracking system according to claim 1, wherein the system further includes a stationary relay device comprising an RF transceiver and a satellite transmitter.

9. The asset group tracking system according to claim 1, wherein the system further includes a mobile terrestrial receiver tracking terminal.

10. The asset group tracking system according to claim 8, wherein the stationary relay device receives asset identification data as assets come within range of its RF transmitter and the stationary relay device transmits the asset identification data to a satellite network.

11. The asset group tracking system according to claim 1, wherein the tracking device with the satellite transmitter delays satellite transmissions when battery power is below a threshold.

12. An animal tracking network comprising a plurality of animals, each animal having at least one tracking tag attached to it, wherein:
a. at least one satellite tracking tag comprises:
i. a GNSS receiver;
ii. a satellite transmitter;
iii. a terrestrial receiver;
iv. a processor controlling the GPS receiver and satellite transmitter;
v. a battery powering one or more of the GPS receiver, terrestrial transmitter, and processor;
b. at least two local tracking tags comprising:
i. a GNSS receiver;
ii. a terrestrial transmitter;
iiii. a processor controlling the GPS receiver and terrestrial transmitter;
iv. a battery powering one or more of the GPS receiver, terrestrial transmitter, and processor; and
c. the local tracking tags transmit location information to the satellite tracking tag and the satellite tracking tag transmits the location information to a satellite network.

13. An asset tracking network comprising a plurality of assets, each asset having at least one tracking device attached to it, wherein:
a. at least one satellite tracking device comprises:
i. a GNSS receiver;
ii. a satellite transmitter;
iii. a terrestrial receiver;
iv. a processor controlling the GPS receiver and satellite transmitter;
v. a battery powering one or more of the GPS receiver, terrestrial transmitter, and processor;
b. at least two local tracking devices comprising:
i. a terrestrial transmitter;
ii. a processor controlling the terrestrial transmitter;
iii. a battery powering the terrestrial transmitter and processor; and
c. the local tracking devices transmit identification information to the satellite tracking device and the satellite tracking device transmits the identification information to a satellite network.

14. The asset tracking network according to claim 13, wherein the local tracking devices have a short range terrestrial transmitter such that the satellite tracking device only receives local tracking device information when the local tracking device is in the vicinity.

15. The asset tracking network according to claim 13, wherein the local tracking devices include GPS receivers and transmits location and/or additional information such as temperature to the satellite tracking device.

16. An asset tracking network including a plurality of asset tracking devices comprising:
a. at least one satellite tracking device comprising:
i. a GNSS receiver;
ii. a terrestrial receiver;
iii. a processor controlling the GPS receiver and satellite transmitter;
iv. a battery powering one or more of the GPS receiver, terrestrial transmitter, and processor;
b. at least two local tracking devices comprising:
i. a terrestrial transmitter;
ii. a processor controlling the terrestrial transmitter;
iii. a battery powering the terrestrial transmitter and processor; and
c. the local tracking devices transmit a data packet to the satellite tracking device and the satellite tracking device transmits the data packet to a data relay network.

17. The asset tracking network of claim 16, wherein the data packet includes at least one of identification information, location data, or sensor data.

18. The asset tracking network of claim 16, wherein the satellite tracking device includes a satellite transmitter.

19. The asset tracking network of claim 16, wherein where the data relay network includes either a satellite network or a cellular network.
